(19) United States
(12) Patent Application Publication
(10) Pub. No.: US 2010/0173188 A1
(43) Pub. Date: Jul. 8, 2010

(54) HUB MOUNT MODULAR BATTERY PACK

(76) Inventors: RAKESH KUMAR DHAWAN, DULLES, VA (US); Jeremy Douglas Boyle, Falls Church, VA (US); Sunil Gupta, Vienna, VA (US); Mohammed Ziaur Rahman, Herndon, VA (US); Mansour Peyghaleh, Sterling, VA (US); Stephen Howard Sayre, Leesburg, VA (US)

Correspondence Address: Electric Motion Systems, LLC, 45150 Business Court , Ste. 300, Dulles, VA, 20166, US

(21) Appl. No.: 12/348,021

(22) Filed: Jan. 2, 2009

(51) Int. Cl. H01M 6/42

(52) U.S. Cl. 429/156

(57) ABSTRACT

The EMS modular battery pack is a convenient and maintainable battery pack that encompasses several modules that are fixed to a rigid structure that carries the battery management system and each module contains several cells which are connected in series via welded leads and are supported mechanically within each module. The division of module facilitates the removal of non-functional cells within the module with ease and the battery pack also provides a battery management system that detects a non functional module using the sensing circuitry built in each module. The modular battery pack design facilitates various configurations of battery pack both electrically and mechanically since any number of modules can be combined to build a battery pack.

### FIELD OF THE INVENTION

The present invention relates to the field of batteries including battery packs of one or more cells and more particularly to a modular battery pack consisting of several mechanically fixed modules with sensing circuit built inside the module and connected end to end in a multi-pack battery module for multiple uses including in light electric vehicles.

### BACKGROUND OF THE INVENTION

There are numerous electrical and electronic devices that are made in portable configurations. For example devices like cellular phones have gained widespread market acceptance. Indeed many business tasks are performed with cellular phones, portable computers, personal digital assistants and similar devices. Similarly electric vehicles, especially electric bicycles are becoming extremely popular as eco friendly and highly efficient substitutes of normal fuel vehicles. The convenience afforded by this portability has significantly increased the speed at which business is conducted or travel is made.

In order to enable portability and usability of a given device such as a cellular phone or an electric bicycle, a suitable and equally portable power source must be developed. Batteries and battery packs are typically used to fulfill this need. The two main factors to be determined in selecting an appropriate battery design are how much power must be provided and for how long. These factors determine the resulting size of the energy source and type of electrochemical system used. Often the size of a battery pack for a given device is substantial, and may rival the size and weight of the device itself. Accordingly, there is an effort in the industry to reduce the size of battery systems.

A serious shortcoming of many battery powered devices is the downtime associated with the replacement of spent batteries. To reduce the frequency of battery replacement, some devices include multiple banks of batteries and use bank-switching to switch from a discharged bank to a fresh bank. In this way, battery replacement can be deferred until all of the banks are drained.

Further a battery pack consists of many individual battery cells connected in series. Conventionally known battery packs with high capacity which comprises a plurality of prismatic cells or battery modules arranged in parallel. Each of the battery modules has a plurality of cells integrally connected in series. A binding rod or a binding band ties the arranged cells or battery modules with end plates disposed at both ends thereof in a parallel direction. Conventional methods of connecting cells together make the battery pack's dimensions and electrical specifications inflexible. Existing battery pack designs also do not allow for easy manufacturing and maintenance since the cells are connected together permanently by welded joints.

Another common problem with many modular batteries is the ease with which batteries can be improperly installed. Incorrect installation causes faulty or no operation of the device and more downtime.

The relevant prior art methods, which will deal with battery pack, are as follows:

US Patent Application No. 20030142490 describes a miniature flashlight includes a high intensity light source supported on a non-conductive battery frame that defines a recess opening outwardly of the battery frame and adapted to receive a replaceable modular self-contained power source, such as a modular battery pack. The battery frame includes a switch side plate which supports a switch slide plate for movement between an “off” position, a first position enabling momentarily closing of a circuit including the light source and battery pack, and a second circuit closing position to continuously energize the light source in response to actuation of an externally exposed switch push button. Side covers are retained on opposite sides of the battery frame and have outer exposed surfaces for receiving indicia thereon. A keyring extension is formed at one end of the battery frame and has a keyring lock that permits keys or other items to be attached to the keyring extension and also facilitates convenient attachment and detachment of the flashlight from clothing items and the like.

US Patent Application No. 20040219422 explains a modular thin-line battery pack for, e.g., motorized window coverings can hold one or two columns of type AA batteries end-to-end. The battery pack has a female socket on one end and a male-ended cord on the other end, and is internally wired such that plugging the male-ended cord of one battery pack into the female socket of a second battery pack results in ganging the packs together in parallel. The present invention consists of modular arrangement encompassing a plurality of battery cells and it is a battery pack that allows replacement of the modules and also facilitates different configurations whereas the given prior art reference is nothing but a battery pack that holds permanently affixed battery cells that are not replaceable, a female socket and male cord arrangement facilitating only parallel configuaration.

US Patent Application No. 20050218868 explains a battery pack for a cordless power and a cordless power tool and battery pack includes the battery pack having a modular interface section that interfaces with the power tool and a battery cup section mated to the modular interface section where the battery cup section has one of a plurality of different battery/voltage configurations. This prior art reference speaks about a battery cup that houses one of the plurality of the different battery configurations mated to a modular interface which in turn interfaces with a power tool whereas the present invention consists of a number of modules affixed to a rigid structure wherein such arrangement can be modified to form battery pack with different configurations due to the presence of non permanent mechanical fastners that connect the module and rigid structure. The battery pack is also replaceable.

US Patent Application No. 20060091849 describes a modular battery pack includes a plurality of battery modules. Each battery module includes a plurality of cells disposed within a cell compartment that is hermetically sealed from a circuit compartment in the battery module. The liquid-impenetrable seal is achieved by insert molding tabs that electrically connect the cell compartment and the circuit compartment. Additionally, the lid of the battery module is ultrasonically welded to the battery module housing. The battery modules are placed into battery module compartments in a main housing, and couple to a main connector by way of a printed circuit board that couples the main connector to battery module connectors on each battery module. The pack ensures that any electrolyte that may leak from a cell does not compromise the electronic circuitry and associated components within the pack. Additionally, the fact that the pack can be separated into modules allows the pack to be shipped in conformity with applicable transportation and safety regulations.

US Patent Application No. 20070295377 discloses a tent having an electrical system. A single battery pack may be used to provide power for lights or other powered components. As examples of lights that may be used, an overhead light may be provided for a central room and a smaller light may be provided for a sleeping room of the tent. In addition, a tent finder, such as a small LED lamp, may be provided that may be attached to the outside of the tent and which may be used for finding the tent in the dark. The light system may utilize a number of extension cords for routing power to the various powered components. The modular tent system may include a variety of attachments or wire holders for routing the extension cords and other wires of the powered system through the modular tent system. This prior art reference does not speak about a modular battery pack but it is mainly about a modular tent system especially meant to provide a light system for a tent deriving power from a battery pack whereas the present invention is about a replaceable modular battery pack only.

U.S. Pat. No. 5,515,303 claims an improved hand-held computer terminal for use in the route distribution industries. The housing of the terminal provides a keypad and sixteen line display and is molded to fit the grip of the user. Circuit boards within the terminal housing arc modular in arrangement and are connected by pin and socket and compressible interconnect strip connectors. High speed data communication between the device and external devices is available. A battery power sensing circuit disables random access memory when low power is sensed and interrupt circuitry permits the terminal to enter an inactive, sleep mode when keypad activity is absent for a predetermined period. A sensing circuit senses the presence of rechargeable batteries. Electrostatic discharge protection is provided by circuit devices integrated into signal carrying lines and no conductive sheathing is required. A removable end cap allows introduction of auxiliary memory cards or the like into a slot under the end cap. A mylar strip is removably positioned between an on board lithium backup battery and its associated circuitry. The mylar strip may be removed by the user when commencement of use occurs. A modular end cap adapts the terminal for radio frequency communication and the like.

U.S. Pat. No. 6,027,828 describes a modular, stackable battery pack and electronic accessory system which allows one or more batteries to simultaneously power one or more electronic accessories. The battery packs and accessories each have two opposing faces which are configured to releasable mate with each other and to provide electrical connection between the components. In some embodiments, the accessory is configured to be one of the terminal ends of the system, and thus has only one face with a releasable connector. The other face may be reserved for operation of the accessory. In other embodiments, the battery packs themselves may also comprise an electronic accessory. Accessories suitable in the practice of this invention include a cellular telephone, a PDA, a pager, a personal stereo (AM/FM radio or cassette, DAT or CD player), a calculator, an alarm clock, an electronic address book, a shaver, a solar powered battery pack recharger, a voice memo recorder, a tazer or a flashlight. The prior art reference is very different from the present invention since the prior art relates to the modular stackable battery pack and electronic accessories and nothing was stated as to the modular battery pack. The present invention only relates to the arrangement of the cells in a replaceable battery pack and to provide a battery pack with different configuration.

U.S. Pat. No. 6,840,650 reveals about a miniature flashlight includes a high intensity light source supported on a non-conductive battery frame that defines a recess opening outwardly of the battery frame and adapted to receive a replaceable modular self-contained power source, such as a modular battery pack. The battery frame includes a switch side plate which supports a switch slide plate for movement between an “off” position, a first position enabling momentarily closing of a circuit including the light source and battery pack, and a second circuit closing position to continuously energize the light source in response to actuation of an externally exposed switch push button. Side covers are retained on opposite sides of the battery frame and have outer exposed surfaces for receiving indicia thereon. A keyring extension is formed at one end of the battery frame and has a keyring lock that permits keys or other items to be attached to the keyring extension and also facilitates convenient attachment and detachment of the flashlight from clothing items and the like.

However the standard battery packs or conventional battery packs are made of many battery cells connected in series to attain a certain current and voltage. The conventional method for connecting these cells electrically is to weld the leads from one cell to the adjacent cell's leads. Because these welded leads do not provide any mechanical support for the cell, the cells are held in place. Since cells in these packs are welded and often affixed permanently with mechanical fasteners, they are very difficult to remove once the pack is assembled. Thus, a battery pack with one or two cells that have gone bad must usually be scrapped.

The present invention modular battery pack design was developed to alleviate this problem. The modular battery pack consists of several modules mechanically affixed to a rigid structure that carries the battery management system. The entire pack is divided into several self contained modules, where the pack becomes easier to maintain since a module can easily be removed.

Further it will be apparent to those skilled in the art that the objects of this invention have been achieved by providing modular battery pack which is unique in nature unlike existing battery packs that are suited only for limited purposes. Various changes may be made in and without departing from the concept of the invention. Further, features of some stages disclosed in this application may be employed with features of other stages. Therefore, the scope of the invention is to be determined by the terminology of the following claims and the legal equivalents thereof.

### SUMMARY OF THE INVENTION

This invention may be summarized, at least in part, with reference to its objects.

The foremost object of this invention is to exclusively present a modular battery pack that has increased maintainability, flexibility and manufacturability

Another object of the present invention is to give a battery pack that has non permanent and flexible electrical connections and mechanical fasteners.

Yet another object of the present invention is to give a convenient and maintainable modular battery pack that identifies a non functioning module which can be readily and easily replaced.

A further object of the present invention is to provide a Modular battery pack encompassing several mechanically fixed modules with sensing circuit built inside the module making it easy for determining which module is not functioning.

Yet another object of the present invention is that the flexible design of the modular battery pack enables reworking of the battery pack with various configurations of the battery pack both electrically and mechanically since any number of modules can be combined to build a battery pack.

Additional objects, advantages and novel features of the invention will be set forth in part in the description which follows, and in part will become apparent to those skilled in the art upon examination of the following, or may be learned by practice of the invention.

These and other objects and advantages and features of the present invention will be more readily apparent when considered in reference to the following description and when taken in conjunction with the accompanying drawings listed below

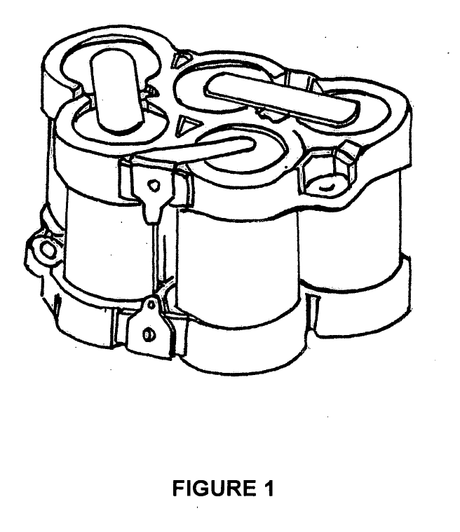

FIG. 1 is a perspective view illustrating the module.

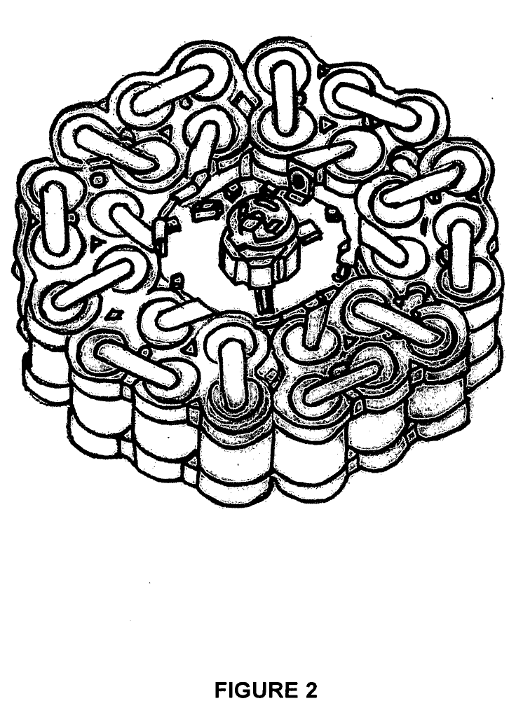

FIG. 2 is a perspective view illustrating the circular battery pack configuration.

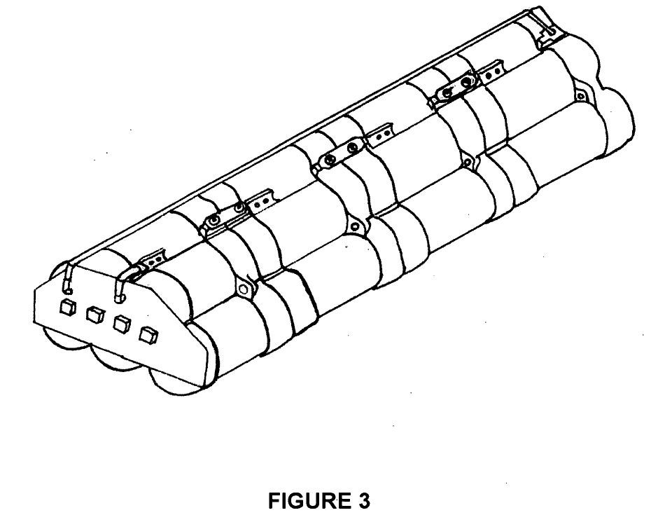

FIG. 3 is a perspective view illustrating the linear battery pack Configuration.

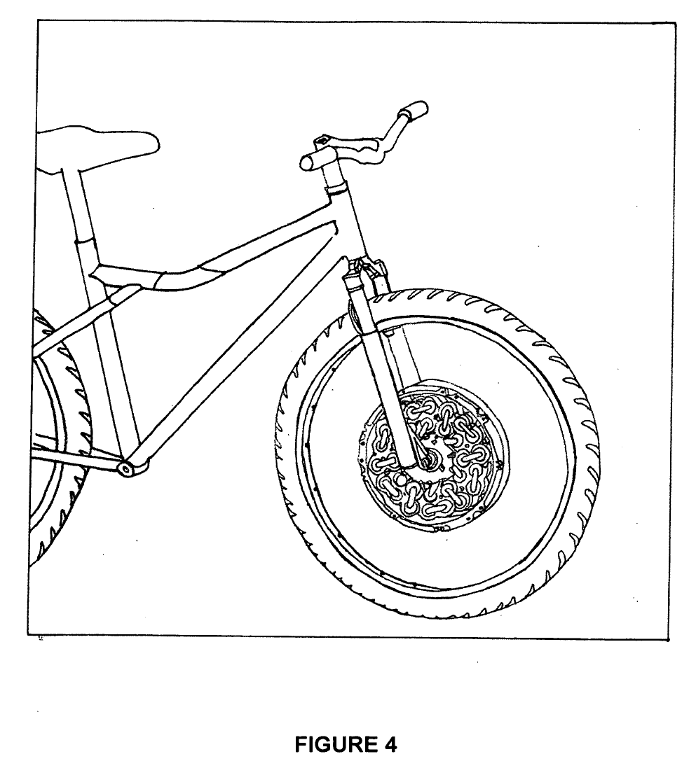

FIG. 4 is a perspective view illustrating the use of a modular battery pack in a light electric vehicle.

### DETAILED DESCRIPTION OF THE INVENTION

The following description is presented to enable any person skilled in the art to make and use the invention, and is provided in the context of particular applications of the invention and their requirements. The present invention can be configured as follows:

The present modular battery pack is designed for use in light electric vehicles such as a 1, 2, 3 or 4 wheeler and powered by an electric motor with an output power of less than 15 kW.

In FIG. 2 the circular modular battery pack configuration is shown which includes several modules, rigid structure at the center and the series of welded lead connections. The number of modules can be changed according to the required configuration of the battery. The present invention consists of several modules each mechanically affixed to a rigid structure at the center. The rigid structure at the middle is made up of thick and strong metal. The rigid metal structure at the middle is designed to suit the structure and configuration of the present battery pack. Individual modules consisting of NiMH (Nickel Metal Hydride) D-cells are attached to the rigid metal structure at the center with the aid of non permanent mechanical fasteners. The non permanent mechanical fasteners are attached to the rigid metal structure in such a way that each individual module are held together and the division of the modular pack in to self contained modules makes it easier for the user to remove the module that has non functioning cells by just unlocking the non permanent mechanical fasteners and again fixing a new module in the place of the old one in the same mechanical way and thus the pack becomes easier to maintain FIG. 1 depicts a perspective view of the housing parts of an individual module consisting of plurality of battery cells, mechanical fasteners and welded lead connections. The individual battery cells consist of components like positive and negative plates, separator material and acid electrolyte. Each individual battery cell in a module is supported by mechanical fasteners inside the module. Each individual cell in the module is connected in series to the other cell by means of lead metal bar which is welded to the top portion of each battery cell. The welded lead connections serve as the electrical connections between the two adjacent cells. The mechanical fasteners hold each individual cell in place permanently and render support to each cell.

Each individual module is designed to hold a sensing circuitry. The sensing circuitry built inside each module is the base for the battery management system. The battery management system determines which module is problematic and helps the user to identify the nonfunctioning module which can be replaced by a new module to keep the battery functioning.

FIG. 3 illustrates the horizontal view of the linear battery pack configuration consisting of several modules each placed on one another and connected in the middle by the non permanent mechanical fasteners. The modules can be arranged in various configurations as the mechanical fasteners and electrical connections between the cells are non permanent.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

It will be apparent to those skilled in the art that the objects of this invention have been achieved by providing the above invention. However various changes may be made in the structure of the invention without departing from the concept of the invention. Therefore, the scope of the invention is to be determined by the terminology of the following claims and the legal equivalents thereof.

What is claimed is:

1. A modular battery pack located inside the hub of a light electric vehicle, comprising of a plurality of battery cells forming part of individual removable and replaceable modules that are fixed to a rigid structure that carries the battery management system, wherein said cells are connected in series or parallel.

2. A modular battery pack as claimed in claim 1, wherein the said modules are easily removable and replaceable that makes manufacturing and maintenance of the whole battery pack cost effective.

3. A modular battery pack as claimed in claim 1, wherein the said modular battery pack includes several modules made up of several battery cells supported by permanent mechanical fasteners.

4. A modular battery pack as claimed in claim 1 wherein the said modular battery pack consists of a rigid metallic structure surrounded by several modules that are connected to the rigid structure through non permanent mechanical fasteners.

5. A modular battery pack as claimed in claim 1 and claim 3, wherein the said non permanent mechanical Fasteners are designed to affix the said modules.

6. A modular battery pack as claimed in claim 1, wherein the said modules comprises of sensing circuitry forming the battery management system built within each module.

7. A modular battery pack as claimed in claim 1, wherein said battery management system detects a non functional module through a sensing circuitry built in each module affixed mechanically to a rigid structure by non permanent mechanical fasteners.

8. A modular battery pack as claimed in claim 1, wherein said battery pack further comprises of welded lead bar connecting individual cells in series or parallel in each module forming the electrical connections inside the battery.

9. A modular battery pack as claimed in claim 1, wherein the said modular battery pack comprising non permanent mechanical fasteners and electrical connections allows several modules to be affixed to the battery to make up different configurations.

10. A modular battery pack as claimed in claim 1, wherein the said modules can be made up of varied chemical kind and size of battery cells.

11. A modular battery pack as claimed in claim 1, wherein the said light electric vehicle is a 1, 2, 3 or 4 wheeler and powered by an electric motor with an output power of less than 15 kW.
